(19) United States
(12) Patent Application Publication
(10) Pub. No.: US 2006/0260446 A1
(43) Pub. Date: Nov. 23, 2006

(54) Tool connecting device

(76) Inventor: Sheng Ming Chang, Taichung Hsien (TW)

Correspondence Address: CHARLES E. BAXLEY, ESQ., 90 JOHN STREET, THIRD FLOOR, NEW YORK, NY, 10038, US

(21) Appl. No.: 11/494,005

(22) Filed: Jul. 27, 2006

Related U.S. Application Data
(63) Continuation-in-part of application No. 11/272,327, filed on Nov. 9, 2005.
Application No. 11/272,327 is a continuation-in-part of application No. 10/830,276, filed on Apr. 21, 2004, now abandoned.

(51) Int. Cl. B25G 1/00; B25B 23/16

(52) U.S. Cl. 81/177.75

(57) ABSTRACT

A tool connecting device includes a tool mount having a non-circular socket opening for receiving a non-circular spatial engaging member of a tool shank to allow the tool shank to be selectively tilted relative to the tool mount to different angular position. An anchoring device may selectively anchor the tool shank and the tool mount together to retain the tool shank in line with the tool mount and to prevent the tool shank from being tilted relative to the tool mount to other angular positions. A magnetic member may attract the spatial engaging member of the tool shank to the tool mount. A retaining member may be attached to the tool mount and engaged with the sleeve for rotatably anchoring the sleeve to the tool mount.

The present invention is a continuation-in-part of U.S. patent application Ser. No. 11/272,327, filed 9, Nov. 2005, pending, which is a continuation-in-part of U.S. patent application Ser. No. 10/830,276, filed 21 Apr. 2004, now abandoned.

### BACKGROUND OF THE INVENTION

1. Field of the Invention

The present invention relates to a tool connecting device, and more particularly to a tool connecting device for connecting a tool shank or a fastener or a work piece or a driven member to a tool mount to allow the tool shank or the fastener or the work piece or the driven member to be selectively secured to the tool mount and rotated in concert with the tool mount or to be rotated or driven by the tool mount or to be selectively tiltable or slantable relative to the tool mount.

2. Description of the Prior Art

Typical tool connecting devices comprise a tool member or a tool bit or a fastener or a work piece secured to a mandrel with a split-ring and arranged to allow the tool bit to be selectively secured to the mandrel and rotated in concert with the mandrel or to be tiltable or slantable relative to the mandrel.

For example, U.S. Pat. No. 5,918,512 to Habermehl et al. discloses one of the typical replaceable bit screwdriver assemblies also comprising a tool bit secured to a mandrel with a split-ring and arranged to allow the tool bit to be selectively secured to the mandrel and rotated in concert with the mandrel or to be tiltable relative to the mandrel. However, an additional lever tool is required to be engaged into the mandrel to selectively disengage the tool bit from the mandrel. In addition, the screwdriver assembly may not be rotated or driven by power tools.

U.S. Pat. No. 6,290,606 to Hodson discloses another typical polygonal ball drive systems for earth auger and also comprising an earth auger selectively coupled or attached to a drive member with a number of balls. However, the earth auger may not be selectively and solidly coupled or attached to the drive member to allow the earth auger to be rotated in concert with or to be rotated or driven by the drive member, especially the power tools.

U.S. Pat. No. 6,874,392 to Wu discloses a further typical connector of hand tool comprising an operating member selectively coupled or attached to a main body with a spring-biased ball. However, the operating member may not be selectively and solidly secured to the main body and may not be selectively and rotatably attached to the main body. The typical connectors may not be provided to rotate or drive the spark plugs that are normally engaged or located in the tiny spaces or the like in the engine chambers of the vehicles. In addition, similarly, the connector of hand tool also may not be rotated or driven by power tools.

The present invention has arisen to mitigate and/or obviate the afore-described disadvantages of the conventional tool connecting devices.

### SUMMARY OF THE INVENTION

The primary objective of the present invention is to provide a tool connecting device for connecting a tool member or a fastener or a work piece or a driven member to a tool mount to allow the tool member or the fastener or the work piece or the driven member to be selectively secured to the tool mount and rotated in concert with the tool mount or to be driven by the tool mount or to be selectively tiltable or slantable relative to the tool mount to various angular positions, and to allow the tool mount to be rotated or driven or worked in tiny or narrower working spaces.

In accordance with one aspect of the invention, there is provided a tool connecting device comprising a tool mount including a first end having a coupling device provided thereon, and including a second end having a non-circular socket opening formed therein and having at least one flat surface formed therein, a tool shank including a non-circular spatial engaging member provided on a first end and selectively engaged with the non-circular socket opening of the tool mount and having at least one curved surface formed therein for selectively engaging with the non-circular socket opening and the flat surface of the tool mount, to allow the tool shank to be selectively tilted relative to the tool mount to different angular position, and the tool shank including a second end for coupling to a tool member, an anchoring device for selectively anchoring the tool shank and the tool mount together to retain the tool shank in line with the tool mount and to prevent the tool shank from being tilted relative to the tool mount to other angular positions, and a sleeve slidably engaged onto the tool mount for being held by a user and for allowing the tool mount to be rotated relative to the sleeve.

The anchoring device includes a protrusion extended from the tool shank for selectively engaging with the socket opening of the tool mount to solidly anchor the spatial engaging member of the tool shank to the tool mount and to prevent the tool shank from being tilted relative to the tool mount.

The tool mount includes a peripheral shoulder formed in an outer portion thereof and having an inner diameter greater than that of the socket opening of the tool mount for selectively engaging with the protrusion of the tool shank.

The tool shank includes a peripheral depression formed therein and arranged for allowing the tool shank to be slanted and tilted relative to the tool mount to different angular position. The tool mount includes a retaining member disposed therein for selectively engaging with the spatial engaging member of the tool shank and for preventing the spatial engaging member of the tool shank from being disengaged from the tool mount.

The tool mount includes a magnetic member disposed therein for attracting the spatial engaging member of the tool shank to the tool mount. The tool mount includes a compartment formed therein to receive the magnetic member therein.

The coupling device is an engaging hole formed in the first end of the tool mount. A retaining member may further be provided and attached to the tool mount and engaged with the sleeve for rotatably anchoring the sleeve to the tool mount and for preventing the sleeve from sliding longitudinally or axially relative to the tool mount.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a tool connecting device in accordance with the present invention;

FIG. 2 is a cross sectional view of the tool connecting device;

FIG. 3 is a cross sectional view similar to FIG. 2, illustrating the operation of the tool connecting device;

FIG. 4 is a further cross sectional view similar to FIGS. 2 and 3, illustrating the other application of the tool connecting device;

FIG. 5 is a further partial exploded view similar to FIG. 1, illustrating the other arrangement or application of the tool connecting device;

FIG. 6 is a cross sectional view of the tool connecting device as shown in FIG. 4, illustrating the operation of the tool connecting device;

FIG. 7 is a still further partial exploded view similar to FIGS. 1 and 5, illustrating the further arrangement or application of the tool connecting device;

FIGS. 8, 9 are cross sectional views of the tool connecting device as shown in FIG. 7, illustrating the operation of the tool connecting device;

FIG. 10 is a still further cross sectional view similar to FIGS. 8 and 9, illustrating the other application of the tool connecting device;

FIG. 11 is a still further partial exploded view similar to FIGS. 1, 5 and 7, illustrating the still further arrangement or application of the tool connecting device; and

FIG. 12 is a cross sectional view of the tool connecting device as shown in FIG. 11, illustrating the operation of the tool connecting device.

### DETAILED DESCRIPTION OF THE PREFERRED EMBODIMENT

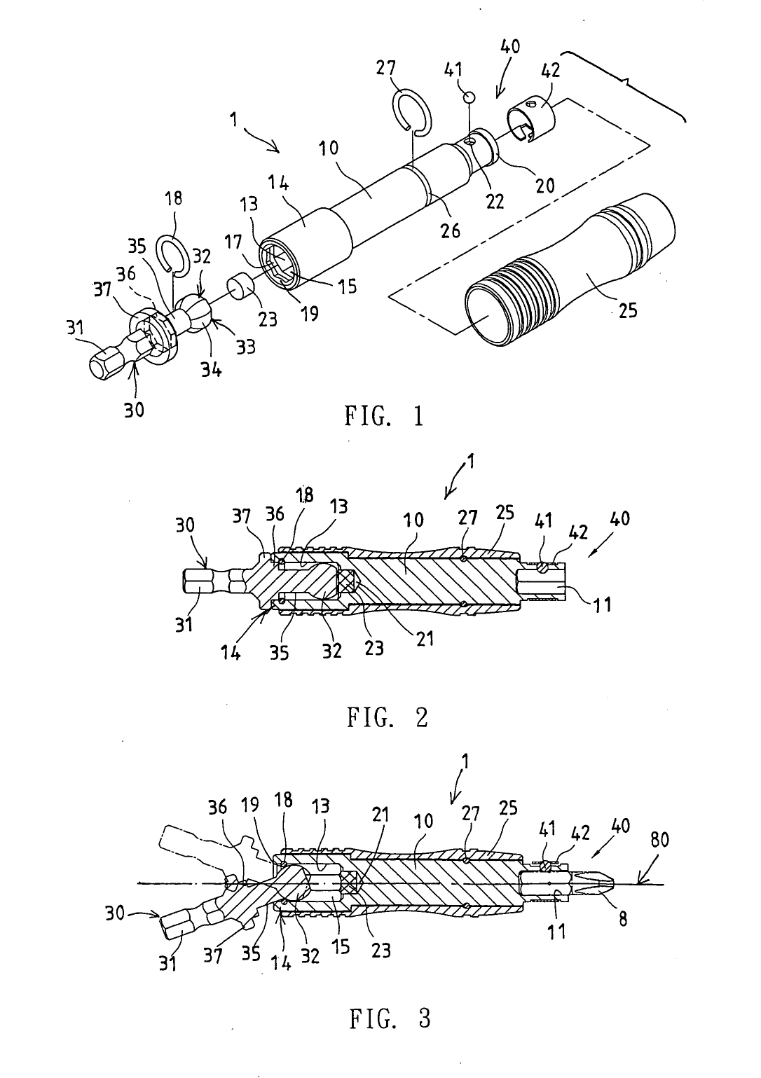

Referring to the drawings, and initially to FIGS. 1-2, a tool connecting device 1 in accordance with the present invention comprises a tool body or tool mount 10 including a coupling device 11, such as an engaging hole 11 provided or formed in one end thereof (FIGS. 2-4, 6, 8-10, and 12) for receiving and for engaging with and for coupling to various driven members 8 therein, such as tool bits 8 (FIGS. 3-4, 6, 9-10, 12), or for engaging with and for coupling to various driving tools (not shown), or the like which may be used to rotate or to drive the tool mount 10, or for allowing the tool mount 10 to be rotated or driven by various driving tools. The tool mount 10 further includes a socket opening 13 formed in the other end 14 thereof for slidably and/or rotatably or pivotally receiving a tool shank 30.

The driven members 8 include a non-circular or hexagonal segment for engaging with the engaging hole 11 of the tool mount 10. It is preferable that the socket opening 13 of the tool mount 10 includes a non-circular cross section, such as a hexagonal cross section having one or more flat surfaces 15 formed therein (FIGS. 1 and 3-6), and includes a peripheral groove 17 formed in the inner peripheral portion thereof for receiving or engaging with a clamping or retaining member 18 therein (FIGS. 1-6, and includes an enlarged peripheral shoulder 19 formed in the outer portion thereof and having an inner diameter greater than that of the socket opening 13 of the tool mount 10. The tool mount 10 further includes a compartment 21 formed therein and communicating with the socket opening 13 of the tool mount 10 to receive or to attach or to secure a magnetic member 23 therein.

As shown in FIGS. 1-4, and 7-10, a retaining means or device 40 may further be provided and attached to one end 20 of the tool mount 10 and engaged with the driven members 8 for stably or firmly or detachably attaching or securing or retaining the driven members 8 to the tool mount 10, in which the tool mount 10 includes an orifice 22 formed in the one end 20 thereof. For example, the retaining device 40 includes a ball or projection 41 engaged into the orifice 22 of the tool mount 10 and a further spring member 42 engaged onto the ball or projection 41 for biasing and forcing the ball or projection 41 to engage with the driven member 8 (FIGS. 2-4, 8-10) and for selectively anchoring or positioning the driven member 8 to the tool mount 10.

Alternatively, as shown in FIGS. 5-6, and 11-12, the retaining device 40 may include an inclined passage 24 formed in the outer peripheral wall 29 of the one end 20 of the tool mount 10, or inclined relative to the peripheral wall 29 of the tool mount 10 and intersecting or communicating with the engaging hole 11 of the tool mount 10 for communicating the engaging hole 11 of the tool mount 10 with the outside of the tool mount 10. An anchoring member or ring 43 is attached or secured onto the outer peripheral portion of the tool mount 10 with such as force-fitted engagements, adhesive materials, or by welding processes and preferably located closer to the one end 20 of the tool mount 10.

A spring member 44, such as a coil spring member 44 is provided and engaged onto the outer peripheral portion of the tool mount 10, and includes one end 45 for engaging with the anchoring member 43 and for being anchored or positioned or attached to the tool mount 10, and includes a bent or spring latching segment 46 formed or provided on the other end thereof for engaging through the inclined passage 24 of the tool mount 10 and for engaging into the engaging hole 11 of the tool mount 10 and for selectively and resiliently engaging with the driven member or screwdriver bit 8. It is arranged that the latching segment 46 of the spring member 44 is engaged with the screwdriver bit 8 when the spring member 44 has not been compressed.

A control ferrule or slidable sleeve 47 is slidably engaged onto the one end 20 of the tool mount 10, and includes a peripheral rib 48 formed on one end thereof for engaging with the spring member 44 and for selectively depressing or compressing the spring member 44 toward the anchoring member 43 or against the spring member 44 by moving the sleeve 47 toward the anchoring member 43, and thus for selectively disengaging or separating the latching segment 46 of the spring member 44 from the screwdriver bit 8, and thus for allowing the screwdriver bit 8 to be disengaged or removed from the tool mount 10. The sleeve 47 may thus be formed and acted as a disengaging means for selectively disengaging or separating the latching segment 46 of the spring member 44 from the screwdriver bit 8.

The sleeve 47 further includes a positioning ring 49 attached to the other end portion thereof for engaging with the anchoring member 43 and for limiting the sleeve 47 to move relative to the tool mount 10, and for preventing the sleeve 47 from being disengaged from the tool mount 10. It is preferable that the peripheral rib 48 is engaged with the other end of the spring member 44 and the spring latching segment 46 of the spring member 44 is resiliently engaged with the screwdriver bit 8 when the positioning ring 49 is biased to engage with the anchoring member 43 by the spring member 44. It is further preferable that the sleeve 47 includes a knurled outer surface formed thereon for allowing the sleeve 47 to be easily moved against the spring member 44 or for facilitating the movement of the sleeve 47 relative to the tool mount 10.

It is to be noted that the spring latching segment 46 is formed integral and bent from the spring member 44 and thus will not be disengaged from the spring member 44 such that the spring latching segment 46 may be easily and quickly engaged through the inclined passage 24 and engaged into the engaging hole 11 of the tool mount 10 to resiliently engage with the screwdriver bit 8 when the spring member 44 is engaged onto the outer peripheral portion of the tool mount 10, without particularly engaging the latching segment 46 of the spring member 44 into the inclined passage 24 of the tool mount 10.

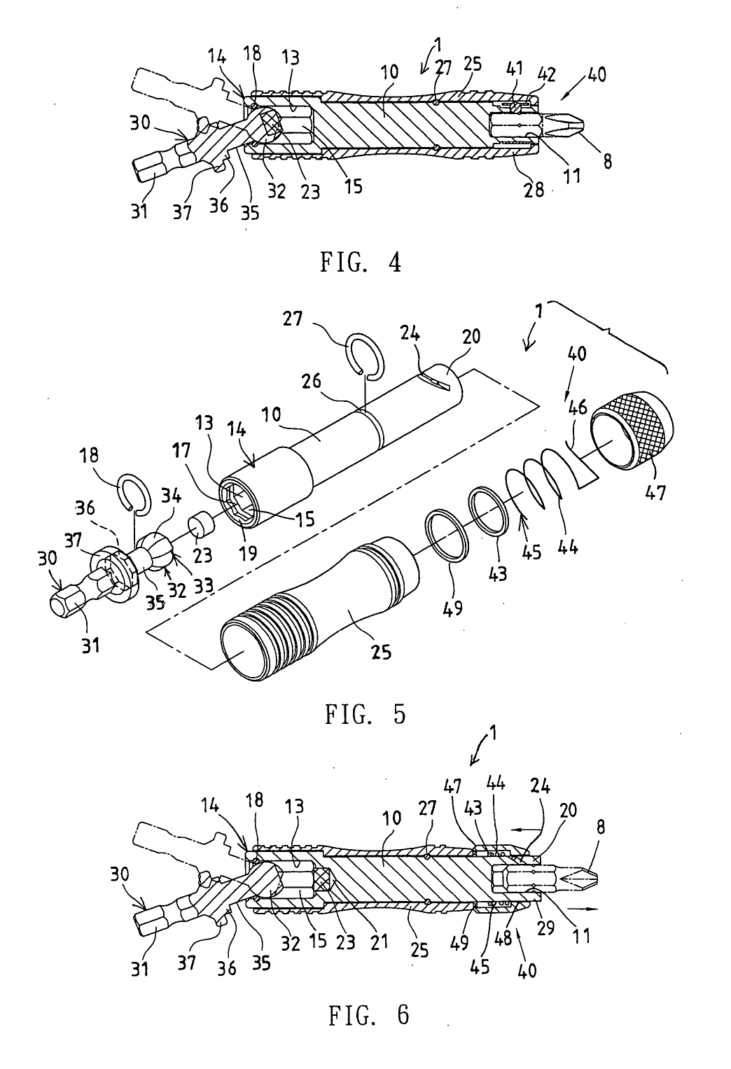

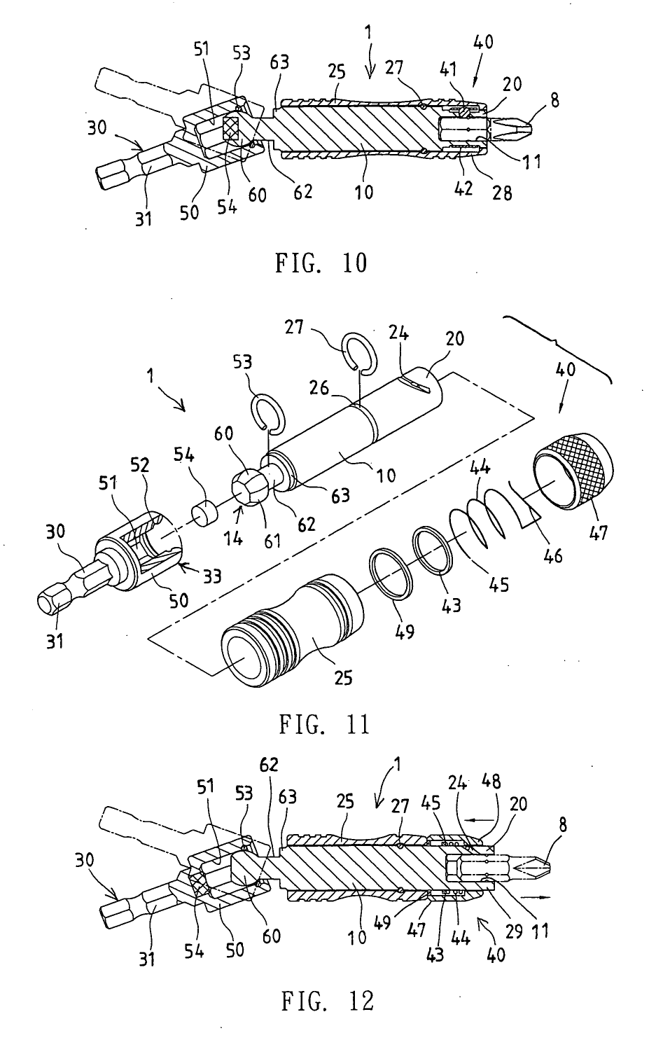

The tool connecting device 1 further includes a sleeve 25 slidably engaged onto the tool mount 10 for being held by the user and for allowing the tool mount 10 to be freely rotated relative to the sleeve 25, and the tool mount 10 may further include a peripheral groove 26 formed in the outer peripheral portion thereof for receiving another clamping or retaining member 27 therein which may be rotatably engaged with the sleeve 25 for rotatably anchoring the sleeve 25 to the tool mount 10 and for preventing the sleeve 25 from being slid or moved longitudinally or axially relative to the tool mount 10. As shown in FIGS. 4 and 10, the sleeve 25 may further include one end portion 28 extended to and located around the one end 20 of the tool mount 10 for shielding and protecting the spring member 42 of the retaining device 40.

Referring again to FIGS. 1-6, the tool shank 30 includes one end 31 for engaging with and for coupling to various driven or driving tools or tool members (not shown), such as wrenches, sockets, power tools, tool extensions, etc., and includes a rounded and spatial engaging member 32 formed or provided on the other end 33 thereof and tiltably or slantably or pivotally received in the socket opening 13 of the tool mount 10 (FIGS. 3-4, 6) for allowing the tool shank 30 to be selectively tilted or slanted or pivoted relative to the longitudinal axis 80 of the tool mount 10 (FIG. 3) when the rounded or spatial engaging member 32 of the tool shank 30 is engaged in the socket opening 13 of the tool mount 10.

The spatial engaging member 32 of the tool shank 30 includes a non-circular cross section, such as a hexagonal or octangular cross section (FIGS. 1, 5) having one or more curved or flat surfaces 34 formed in outer peripheral portion thereof for engaging with the corresponding non-circular socket opening 13 and/or the corresponding flat surfaces 15 of the tool mount 10 for allowing the spatial engaging member 32 to be tilted or pivoted relative to the longitudinal axis 80 of the tool mount 10 to different angular position as shown in FIG. 3, and also for allowing the spatial engaging member 32 to be rotated or driven by the tool mount 10 when the tool mount 10 is rotated or driven by the driving tools (not shown), by the engagement of the curved surfaces 34 of the tool shank 30 and the flat surfaces 15 of the tool mount 10.

The tool shank 30 further includes a peripheral depression 35 formed therein, such as formed in the middle portion thereof and located between the spatial engaging member 32 and the tool shank 30 for selectively engaging with the retaining member 18 (FIG. 3) which may anchor and secure the spatial engaging member 32 of the tool shank 30 in engagement with the tool mount 10, and for preventing the spatial engaging member 32 of the tool shank 30 from being disengaged from the tool mount 10. The formation or the provision of the peripheral depression 35 in the tool shank 30 allows the tool shank 30 to be suitably and selectively slanted or tilted or pivoted relative to the longitudinal axis 80 of the tool mount 10 to different angular position.

The tool shank 30 further includes a peripheral protrusion 36 formed thereon or extended therefrom, such as formed and located closer to the tool shank 30 or extended into the peripheral depression 35 of the tool shank 30, but spaced away from or distal to the spatial engaging member 32 for selectively engaging with or into the enlarged peripheral shoulder 19 of the tool mount 10 when the spatial engaging member 32 of the tool shank 30 is completely engaged into the socket opening 13 of the tool mount 10 (FIG. 2), in order to stably or solidly anchor or secure the spatial engaging member 32 of the tool shank 30 to the tool mount 10 and to prevent the tool shank 30 from being slanted or tilted or pivoted relative to the longitudinal axis 80 of the tool mount 10. The peripheral protrusion 36 may include a circular or a non-circular (FIGS. 1, 5) shape for engaging with the corresponding peripheral shoulder 19 of the tool mount 10. The tool shank 30 further includes a further enlarged peripheral fence 37 formed integral with such as the peripheral protrusion 36 and having an outer diameter greater than that of the peripheral protrusion 36 for engaging with the other end 14 of the tool mount 10 and for anchoring or positioning the tool shank 30 to the tool mount 10 (FIG. 2).

In operation, as shown in FIG. 2, the peripheral protrusion 36 of the tool shank 30 may be selectively engaged with or into the enlarged peripheral shoulder 19 of the tool mount 10 to stably or solidly anchor or secure the spatial engaging member 32 of the tool shank 30 to the tool mount 10 and to prevent the tool shank 30 from being slanted or tilted or pivoted relative to the longitudinal axis 80 of the tool mount 10 and to allow the tool shank 30 to be retained in line with the longitudinal axis 80 of the tool mount 10, and thus to allow the tool shank 30 to be solidly and effectively rotated or driven by the tool mount 10. The magnetic member 23 may be used to attract the spatial engaging member 32 of the tool shank 30 to the tool mount 10 and to position or anchor the spatial engaging member 32 of the tool shank 30 or the driving members to the tool mount 10. Alternatively, as shown in FIG. 4, the magnetic member 23 may be attached to the spatial engaging member 32 of the tool shank 30 for attracting the spatial engaging member 32 of the tool shank 30 to the tool mount 10.

As shown in FIG. 3, when the peripheral protrusion 36 of the tool shank 30 is disengaged or separated from the socket opening 13 of the tool mount 10 and/or when the retaining member 18 is selectively engaged with the peripheral depression 35 of the tool shank 30, the spatial engaging member 32 of the tool shank 30 may be anchored or secured or retained in engagement with the tool mount 10 to prevent the spatial engaging member 32 of the tool shank 30 from being disengaged from the tool mount 10, but to allow the tool shank 30 to be suitably and selectively slanted or tilted or pivoted relative to the longitudinal axis 80 of the tool mount 10 to different angular position. The engagement of the curved surfaces 34 of the tool shank 30 with the flat surfaces 15 of the tool mount 10 allows the tool mount 10 to be rotated or driven by the tool shank 30 even when the tool shank 30 is slanted or tilted relative to the longitudinal axis 80 of the tool mount 10 to different angular position.

It is to be noted that the various driven or driving tools that are attached or coupled to the tool shank 30 may be engaged or located in the tiny spaces or the like in the vehicles or in the other machines or facilities and may not be easily reached and rotated or driven by various driving members or tools. With the tool connecting device in accordance with the present invention, the tool shank 30 may be suitably and selectively slanted or tilted relative to the tool mount 10 to different angular position and to allow various driven members 8 to be suitably rotated or driven by the tool mount 10 and the tool shank 30. The peripheral protrusion 36 of the tool shank 30 may be used or acted as an anchoring means or device for selectively anchoring or securing the tool shank 30 and the tool mount 10 together, and for anchoring or retaining the tool shank 30 in line with the tool mount 10 and for preventing the tool shank 30 from being tilted relative to the tool mount 10 to the other angular positions.

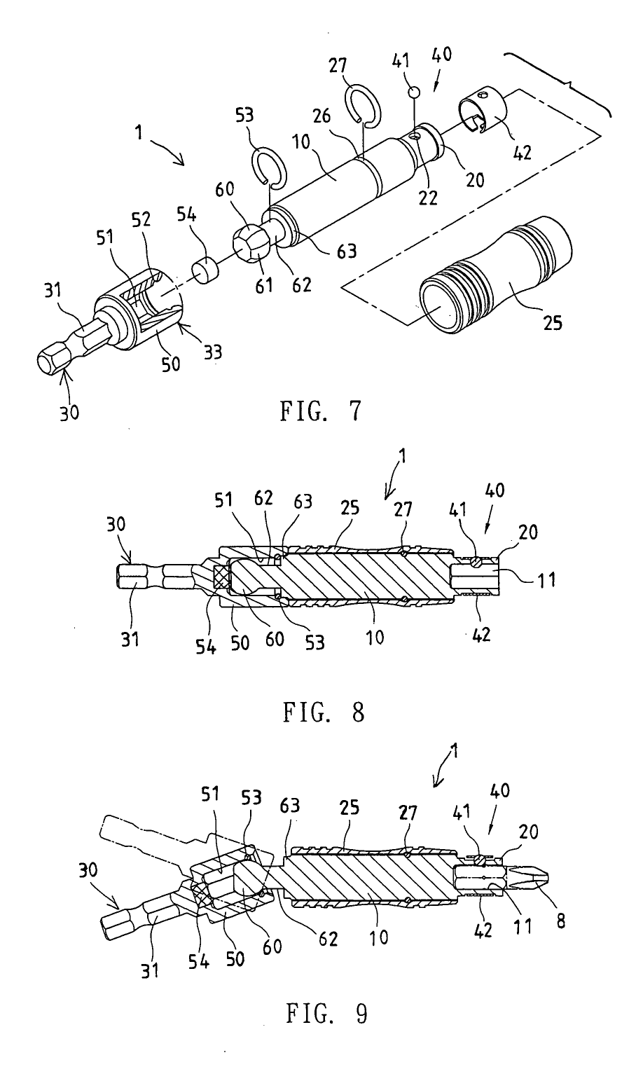

Alternatively, as shown in FIGS. 7-12, the tool shank 30 may include a housing 50 formed or provided on the other end 33 thereof and having a socket opening 51 formed in the housing 50, and includes a peripheral groove 52 formed in the inner peripheral portion thereof for receiving or engaging with a clamping or retaining member 53 therein, and includes a magnetic member 54 engaged in the socket opening 51 of the housing 50. The tool mount 10 may include a rounded and spatial engaging member 60 formed or provided on the other end 14 thereof and tiltably or slantably or pivotally received in the socket opening 51 of the housing 50 for allowing the tool shank 30 to be selectively tilted or slanted or pivoted relative to the longitudinal axis of the tool mount 10 when the rounded or spatial engaging member 60 of the tool mount 10 is engaged in the socket opening 51 of the housing 50.

The spatial engaging member 60 of the tool mount 10 also includes a non-circular cross section, such as a hexagonal or octangular cross section having one or more curved or flat surfaces 61 formed in outer peripheral portion thereof for engaging with the corresponding non-circular socket opening and/or the corresponding flat surfaces of the housing 50 for allowing the spatial engaging member 60 to be tilted or pivoted relative to the longitudinal axis of the housing 50 to different angular position, and also for allowing the spatial engaging member 60 to be rotated or driven by the housing 50 when the housing 50 is rotated or driven by the driving tools (not shown), by the engagement of the curved surfaces of the spatial engaging member 60 of the tool mount 10 and the flat surfaces of the housing 50.

The tool mount 10 further includes a peripheral depression 62 formed therein, such as formed in the middle portion thereof and located between the spatial engaging member 60 and the tool mount 10 for selectively engaging with the retaining member 53 which may anchor and secure the spatial engaging member 60 of the tool mount 10 in engagement with the housing 50, and for preventing the spatial engaging member 60 of the tool mount 10 from being disengaged from the housing 50. The formation or the provision of the peripheral depression 62 in the tool mount 10 allows the tool mount 10 to be suitably and selectively slanted or tilted or pivoted relative to the longitudinal axis of the housing 50 to different angular position.

The tool mount 10 further includes a peripheral protrusion 63 formed thereon or extended therefrom, such as formed and located closer to the tool mount 10 or extended into the peripheral depression 62 of the tool mount 10, but spaced away from or distal to the spatial engaging member 60 for selectively engaging with or into the enlarged peripheral shoulder of the housing 50 when the spatial engaging member 60 of the tool mount 10 is completely engaged into the socket opening 51 of the housing 50, in order to stably or solidly anchor or secure the spatial engaging member 60 of the tool mount 10 to the housing 50 and to prevent the tool mount 10 from being slanted or tilted or pivoted relative to the longitudinal axis of the housing 50. The peripheral protrusion 63 may include a circular or a non-circular shape for engaging with the corresponding peripheral shoulder of the housing 50.

The magnetic member 54 may be used to attract the spatial engaging member 60 of the tool mount 10 to the housing 50 and to position or anchor the spatial engaging member 60 of the tool mount 10 to the housing 50 of the tool shank 30 or the driving members. Alternatively, as shown in FIG. 10, the magnetic member 54 may be attached to the spatial engaging member 60 of the tool mount 10 for attracting the spatial engaging member 60 of the tool mount 10 to the housing 50 or the tool shank 30.

Accordingly, the tool connecting device in accordance with the present invention may be provided for connecting a tool shank or a fastener or a work piece or a driven member to a tool mount to allow the tool shank or the fastener or the work piece or the driven member to be selectively secured to the tool mount and rotated in concert with the tool mount or to be rotated or driven by the tool mount or to be selectively tilted or pivoted relative to the tool mount to various angular positions.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool connecting device comprising:
a tool mount including a first end having a coupling device provided thereon, and including a second end having a non-circular socket opening formed therein and having at least one flat surface formed therein,
a tool shank including a non-circular spatial engaging member provided on a first end and selectively engaged with said non-circular socket opening of said tool mount and having at least one curved surface formed therein for selectively engaging with said non-circular socket opening and said at least one flat surface of said tool mount, to allow said tool shank to be selectively tilted relative to said tool mount to different angular position, and said tool shank including a second end for coupling to a tool member,
means for selectively anchoring said tool shank and said tool mount together to retain said tool shank in line with said tool mount and to prevent said tool shank from being tilted relative to said tool mount to other angular positions, and
a sleeve slidably engaged onto said tool mount for being held by a user and for allowing said tool mount to be rotated relative to said sleeve.

2. The tool connecting device as claimed in claim 1, wherein said anchoring means includes a protrusion extended from said tool shank for selectively engaging with said socket opening of said tool mount to solidly anchor said spatial engaging member of said tool shank to said tool mount and to prevent said tool shank from being tilted relative to said tool mount.

3. The tool connecting device as claimed in claim 2, wherein said tool mount includes a peripheral shoulder formed in an outer portion thereof and having an inner diameter greater than that of said socket opening of said tool mount for selectively engaging with said protrusion of said tool shank.

4. The tool connecting device as claimed in claim 1, wherein said tool shank includes a peripheral depression formed therein and arranged for allowing said tool shank to be slanted and tilted relative to said tool mount to different angular position.

5. The tool connecting device as claimed in claim 4, wherein said tool mount includes a retaining member disposed therein for selectively engaging with said spatial engaging member of said tool shank and for preventing said spatial engaging member of said tool shank from being disengaged from said tool mount.

6. The tool connecting device as claimed in claim 1, wherein said tool mount includes a magnetic member disposed therein for attracting said spatial engaging member of said tool shank to said tool mount.

7. The tool connecting device as claimed in claim 6, wherein said tool mount includes a compartment formed therein to receive said magnetic member therein.

8. The tool connecting device as claimed in claim 1, wherein said coupling device is an engaging hole formed in said first end of said tool mount.

9. The tool connecting device as claimed in claim 1, wherein a retaining member is attached to said tool mount and engaged with said sleeve for rotatably anchoring said sleeve to said tool mount.
